(19) United States
(12) Patent Application Publication
(10) Pub. No.: US 2006/0289004 A1
(43) Pub. Date: Dec. 28, 2006

(54) Air purifying escape hood

(75) Inventors: Manuel Saez, Brooklyn, NY (US); Lachezar Tsvetanov, Bridgeport, CT (US); Maximo Diaz Heer, Jackson Heights, NY (US); Matthew L. Chin, New York, NY (US); Dean B. Chapman, Montclair, NJ (US); Douglas Song, New York, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Humanscale Corporation

(21) Appl. No.: 11/157,121

(22) Filed: Jun. 20, 2005

Related U.S. Application Data
(60) Provisional application No. 60/581,482, filed on Jun. 21, 2004.

(51) Int. Cl. A62B 18/00; A62B 17/04

(52) U.S. Cl. 128/201.24

(57) ABSTRACT

The present invention is directed to an air purifying escape hood that protects a user from acute environmental hazards by filtering contaminants and providing breathable air for a time sufficient to escape the hazard. The air purifying escape hood comprises a hood assembly that covers the head of the user and a filter assembly that filters contaminants and provides a flow of purified air to a user. The air purifying escape hood is particularly useful in protecting a user from smoke, allowing the user to safely escape a burning building and is further useful for protection against non-smoke related particulates, chemical and biological contaminants, and radiological/nuclear contaminants.

### CROSS-REFERENCE TO RELATED APPLICATION

This application claims the benefit of U.S. Provisional Application No. 60/581,482, filed Jun. 21, 2004, which is incorporated herein in its entirety.

### FIELD OF THE INVENTION

The present invention is directed to an air purifying escape hood. The escape hood is useful for protecting a user from smoke, chemical agents, biological agents, and the like, and generally comprises a hood assembly and a filter assembly, which preferably includes a HEPA filter.

### BACKGROUND

Personal safety devices are increasingly becoming items of great demand. Historically, such devices have been viewed as mere novelty items or as possible indicators of paranoia. More recently, however, personal safety items have gained popularity as more people have come to recognize the need for, and the usefulness of, such devices.

For example, fire extinguishers have commonly been limited to businesses or other public facilities. Over time, though, the need for fire extinguishers in more personal settings, such as homes, has been recognized. Accordingly, many homes in America now have at least one fire extinguisher, and many people keep smaller fire extinguishers close at hand in case of emergency, such as in vehicles. Similarly, most homes in America have at least one smoke detector to provide early warning of a possibly deadly fire and to help facilitate escape.

In light of advances in technology, personal safety devices are increasingly more accessible. Further, there is an increasing realization of possible dangers from disasters, both accidental and purposeful, including exposure to toxic chemical gases, biological agents, and even radiological/nuclear events. Accordingly, the usefulness of emergency breathing equipment for providing temporary protection from such dangers and allowing the user time to move to an area of safety is becoming more evident.

Emergency breathing equipment has long been known and is commonly used by emergency rescue personnel, such as firemen. Such professional equipment generally encompasses oxygen tanks, hoses, and bulky masks and headgear. Accordingly, it is not feasible, either practically or monetarily, for private individuals to employ such equipment for personal use.

One alternative previously suggested is the Exitair® Smoke Hood available from Kaptair. The Exitair® Smoke Hood is a mask for evacuation from a fire scene and is generally composed of a transparent hood portion, an active carbon filter, a Neoprene® band for creating an airtight seal around the user's neck, and adhesives. While such a device is convenient and compact, it has several limitations. First, it is limited in its ability to provide total protection from enviromnental hazards in its use of an activated carbon filter. It is known, however, that standard activated carbon often lacks sufficient capacity for some reactive gases. Further, its greatest effectiveness is generally limited to organic compounds, metals, chlorine, and similar pollutants. The effectiveness of activated carbon is also dependant upon particle size distribution, and the adsorptive ability can vary greatly depending upon particle size. Accordingly, the effectiveness of devices, such as described above, is generally limited to smoke, such as that generated in home or business fires and would not be as effective in more complex fire, such as an industrial fire.

Smoke hoods such as described above are also limited in the ability to regulate air pressure within the hood and effectively bring in a sufficient volume of clean air. Air exchange by the user takes place completely within the hood. Some clean, oxygenated air is brought in to the user through the charcoal filter sections of the hood, but the pressure differential generated by the natural breathing of the user is insufficient to create quality air flow through the filter sections. Simultaneously, air expelled by the user is expelled into the hood providing an undesirable proportion of carbon dioxide to oxygen within the hood. Accordingly, while the user breathes within the hood, the user is inhaling a small amount of fresh oxygen but is inhaling a greater than normal amount of carbon dioxide, which can lead to oxygen deprivation, particularly in a situations where the user is likely to be breathing heavier than normal and needing increased amounts of oxygen.

U.S. Pat. No. 5,186,165 describes another smoke hood of limited usefulness. The smoke hood is marketed under the tradename Evac-U8™. The patent teaches a smoke hood comprising a hood integrally attached to a mouthpiece. The mouthpiece is arranged on the inside of the hood and attaches to a canister situated on the outside of the hood. The canister has layered filtering material that includes activated carbon granules, a desiccant, a catalyst for converting carbon monoxide to carbon dioxide, and electrostatically charged filters between the layers. The mouthpiece includes inhalation and exhalation check valves and an external nose clip to prevent breathing through the nose.

The smoke hood of the '165 patent is similarly limited in its effectiveness, the main filtering device being limited to activated charcoal. Filtered air is more easily brought in to the user through the mouthpiece/filter arrangement that more efficiently moves air from outside the hood to inside the hood, directly to the user's mouth. The hood, however, is left partially open to the atmosphere, relying solely on positive air pressure within the hood from the air exhaled by the user to keep smoke and other gases out of the hood.

Smoke hoods, such as those generally described, have a limited scope of usefulness. For example, these devices would not be expected to be effective for protecting a user against chemical or biological agents. Similarly, radiological/nuclear contaminants would also be expected to be outside the effective range of such devices.

Accordingly, it would be useful to have an air purifying evacuation breathing apparatus that is effective in protecting a user for a significant period of time against a large variety of airborne health hazards. Particularly, it would be useful to have an apparatus providing protection against not only smoke, but also chemical, biological, and radiological/nuclear hazards. Furthermore, it would be useful to have such an apparatus that is compact, easy to use, and conveniently storable for an extended time.

### SUMMARY OF THE INVENTION

According to the present invention, there is provided a multipurpose, disposable air purifying escape hood for personal use by an individual user to facilitate movement by the user from an area of dangerous air contamination to an area of safety. In particular, the air purifying escape hood is effective for allowing an individual user to escape from a fire-related area that is overcome with smoke and associated toxic gases. Preferentially, the air purifying escape hood is also effective for allowing an individual user to escape from areas of further acute airborne contamination, such as by particulate matter, chemical contamination, biological agents, and radiological/nuclear disasters.

In one aspect of the invention, there is provided an air purifying escape hood generally comprising a hood assembly and a filter assembly. In one particular embodiment, the hood assembly comprises a hood body and a hood visor. Preferentially, the hood assembly further comprises a neck seal component. In another embodiment, the filter assembly comprises of a HEPA filter, and a mouthpiece. Preferentially, the filter assembly further comprises a first check valve and a second check valve, the two valves being particularly useful for controlling the flow of air from the filter device to the mouthpiece and controlling the flow of air from the mouthpiece to an exhalation outlet. In one preferred embodiment, the filter assembly further comprises an air distribution chamber where filtered air for inhalation and exhaled air for movement out of the air purifying escape hood are exchanged.

In one particular embodiment of the invention, the air purifying escape hood comprises a hood assembly and a filter assembly. The hood assembly, according to this embodiment, comprises a hood body having an inner layer and an outer layer, a hood visor, and a silicon rubber neck band. Preferably, according to this embodiment, the filter assembly comprises a HEPA filter, a mouthpiece, an air distribution chamber, a first check valve for allowing movement of air from the HEPA filter to the air distribution chamber for inhalation, and a second check valve for allowing movement of expelled air out of the air distribution chamber. Preferentially, the first check valve and the second check valve are aligned in parallel.

According to another aspect of the invention, there is provided a packaged air purifying escape hood for emergency breathing. The packaged escape hood is preferably provided in a compact, easily storable form, and is further preferably provided in a form wherein most users recognize and can easily identify the method of opening the packaged escape hood, even in an emergency situation.

In one particular embodiment according to this aspect of the invention, the packaged escape hood comprises an air purifying escape hood comprising a hood assembly comprising a hood body and a hood visor, and a filter assembly comprising a HEPA filter, a mouthpiece, an air distribution chamber, a first check valve, and a second check valve, wherein the air purifying escape hood is packaged in a storage container comprising a sealable container and a sealing container lid. In one particularly preferred embodiment, the air purifying escape hood is vacuum sealed in the sealable container with the sealing lid. Further, preferentially, the sealing lid comprises a pull ring, such as commonly found on tennis ball cans, for example, such that the method of opening is easily recognizable.

### BRIEF DESCRIPTION OF THE DRAWINGS

FIG. 1A provides a front view of an air purifying escape hood according to one embodiment of the invention;

FIG. 1B provides a side view of an air purifying escape hood according to one embodiment of the invention;

FIG. 2 provides an illustration of one embodiment of an air purifying escape hood according to the invention being worn by a user;

FIG. 3 provides an exploded view of an air purifying escape hood according to one embodiment of the invention;

FIG. 4 provides a rear view of a filter assembly for use in an air purifying escape hood according to one embodiment of the invention;

FIG. 4B provides a sectional view of the filter assembly provided in FIG. 4 as taken along the line B-B;

FIG. 5 provides a front perspective view of a mouthpiece for use in an air purifying escape hood according to one embodiment of the invention;

FIG. 6 provides a top view of a mouthpiece for use in an air purifying escape hood according to one embodiment of the invention;

FIG. 7 provides a rear view of a mouthpiece for use in an air purifying escape hood according to one embodiment of the invention;

FIG. 7A provides a sectional view of the mouthpiece provided in FIG. 7 as taken along the line A-A; and

FIG. 8 provides a perspective view of a sealed storage container for storing an air purifying escape hood according to one embodiment of the invention.

### DETAILED DESCRIPTION OF THE INVENTION

The present inventions now will be described more fully hereinafter with reference to specific embodiments of the invention and to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise. Like numbers refer to like elements throughout.

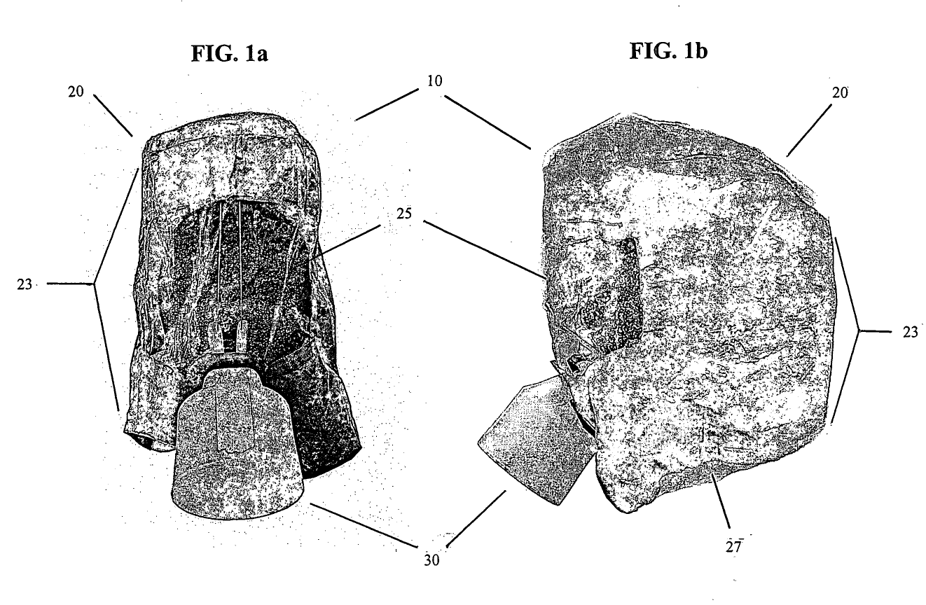

The invention described herein provides an air purifying escape hood useful for providing a user purified, breathable air to protect the user, particularly in an emergency setting, from contaminants, such as smoke, particulate matter, chemical contamination, biological agents, and radiological/nuclear agents. FIG. 1a and FIG. 1b show front and side views, respectively, of one embodiment of the air purifying escape hood of the invention. The escape hood 10 generally comprises a hood assembly 20 and a filter assembly 30. As seen in the embodiment of FIG. 1a and FIG. 1b, the hood assembly 20 comprises a hood body 23, a hood visor 25, and a neck seal 27.

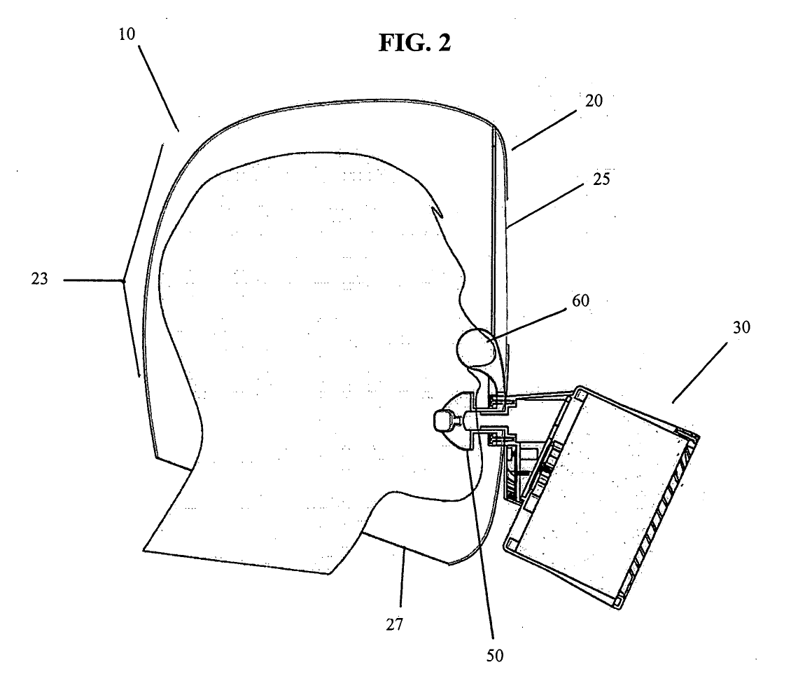

FIG. 2 shows an illustration of an air purifying escape hood 10 being worn by a user. The hood assembly 20 is covering the head of the user, with the neck seal 27 at the level of the user's neck. The filter assembly 30 is beneficially positioned around the level of the user's mouth. Accordingly, as shown in FIG. 2, the mouthpiece 50 of the filter assembly 30 is shown inserted into the user's mouth. Further, the nose blocker component 60 of the filter assembly 30 is optimally positioned just above the mouthpiece 50, and is shown positioned on the user's nose to prevent the user from breathing through the nose while using the air purifying escape hood 10.

The hood assembly is preferentially pliable, roughly sack-shaped, and is sized to comfortably cover the head and at least part of the neck of users of various sizes, from children to adults. The hood body preferably comprises a material that is heat resistant, most beneficially being fire resistant, and has low or no air permeability. In a particularly preferred embodiment, the hood body comprises one or more materials exhibiting low or no permeability to biological agents, such as viral or bacterial agents, and is also chemical resistant.

In one embodiment, the hood body comprises a plurality of layers. The multiple layers can comprise same or different materials, including composite materials. Preferably, the various layers are bonded together; however, the invention also encompasses variations wherein the layers can be partially bonded or separated by an intermediate.

According to one particular embodiment of the invention, the hood body comprises an outer layer and an inner layer. The outer layer preferably comprises a fire-retardant or fire-resistant material. Any material generally recognized in the art as fire-retardant or fire-resistant could be used in the outer layer according to the invention. Non-limiting examples of such materials useful in the outer layer of the hood body include materials incorporating aromatic polyamides, such as materials sold under the tradename NOMEX, halogen-containing polymers, such as polychloroprenes (exemplified by materials sold under the tradename NEOPRENE), and polyester resins, such as materials sold under the tradename ZYTRON.

The inner layer of the hood body preferably comprises a material providing protection against smoke, chemicals, and biological agents. Accordingly, any material recognizable by one of skill in the art as being chemically inert, and particularly as partially or totally preventing passage of particulate matter, such as found in smoke, as well as biological agents, could be used in the inner layer of the hood body. Non-limiting examples of materials useful according to the invention include polytetrafluoroethylene (PTFE) based products, such as those sold under the tradename TEFLON.

The hood visor component of the hood assembly is preferably situated above the area where the hood assembly is interconnected to the filter assembly. The visor component generally corresponds to the face area of a prospective user and preferentially covers a significant area of the hood assembly to allow for good visibility for the user. Accordingly, the visor component should be light transparent. The visor component can be continuous with the hood body of the hood assembly or can be sealably attached to the head body. Preferably, the hood visor interacts with the hood body and is formed of a material such that contaminants intended to be excluded by the hood body are also excluded by the hood visor.

The bottom portion of the hood assembly is open allowing access for the head of the user in the hood assembly. The opening at the bottom portion of the hood assembly is preferentially sufficiently large in size to allow comfortable access for users having various head sizes.

In one embodiment of the invention, the opening at the bottom portion of the hood assembly further comprises a neck seal component. The neck seal component can comprise a particular conformation of the hood assembly that provides an expandable opening for insertion of the head that will thereafter reassume the smaller conformation for providing a tight seal around the neck of the user. Alternatively, the neck seal can include a material, such as a stretch material, that can be stretched to allow the user to put the hood assembly over the head but will return to the original shape to form a tight seal around the user's neck.

In a particularly preferred embodiment of the invention, the neck seal component includes a band of silicon rubber integrally attached to the opening at the bottom of the hood assembly. The band of silicon rubber is preferably attached to the hood assembly such that particulate matter, chemical agents, biological agents, and the like are excluded from passing through the area of attachment. Further, the band of silicon rubber is preferably of a size that it will fit tightly around the neck of a small child but have a stretch capacity enabling accommodation of even larger adults. Of course, the band should not fit so tightly so as to cut off circulation in the neck of the user; however, the fit should be tight enough to impede free flow of air, particularly smoke, into the interior of the hood assembly.

As shown in FIGS. 1a through 2, the filter assembly interacts with the hood assembly such that a portion of the filter assembly is external to the hood assembly and a portion of the filter assembly is internal to the hood assembly. Preferably, the filter assembly is attached to the hood assembly in a position directly below the visor portion of the hood assembly.

In one particular embodiment of the invention, the filter assembly is sealably attached to the hood assembly. Any method of attachment known in the art for forming an air-tight seal around the filter assembly at the point of attachment to the hood assembly could be used. Preferentially, the seal is impermeable to air, smoke, other particulate matter, and biological agents. Furthermore, the seal is preferably chemically resistant.

The filter assembly, according to the invention, generally comprises a filter component, a mouthpiece component, and two valves interposed between the filter component and the mouthpiece component. Further additional components can also be included in the filter assembly to provide preferred embodiments of the invention. In one preferred embodiment, the filter component includes a HEPA filter.

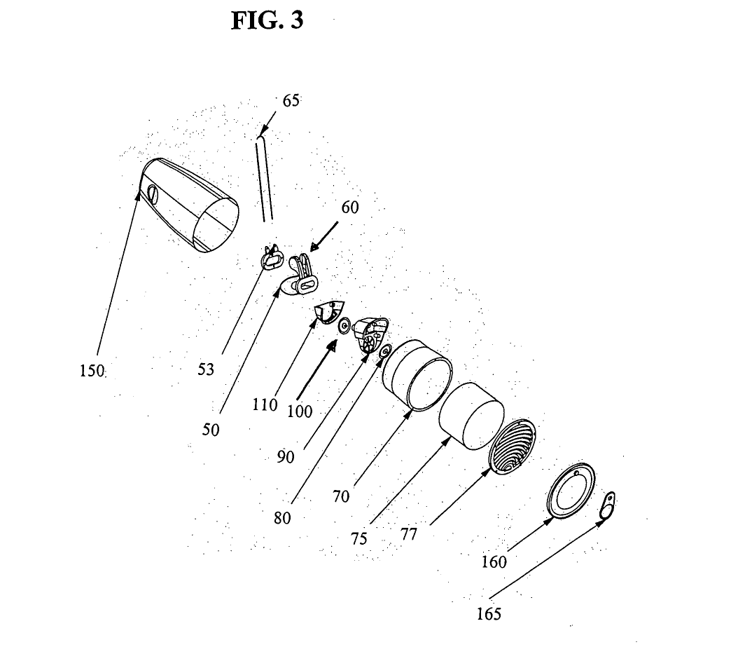

One particular embodiment of the filter assembly of the invention is illustrated in FIG. 3, which shows an exploded view of the filter assembly. This view shows the component parts of one filter assembly according to the invention, including a storage container for packaging the air purifying escape hood.

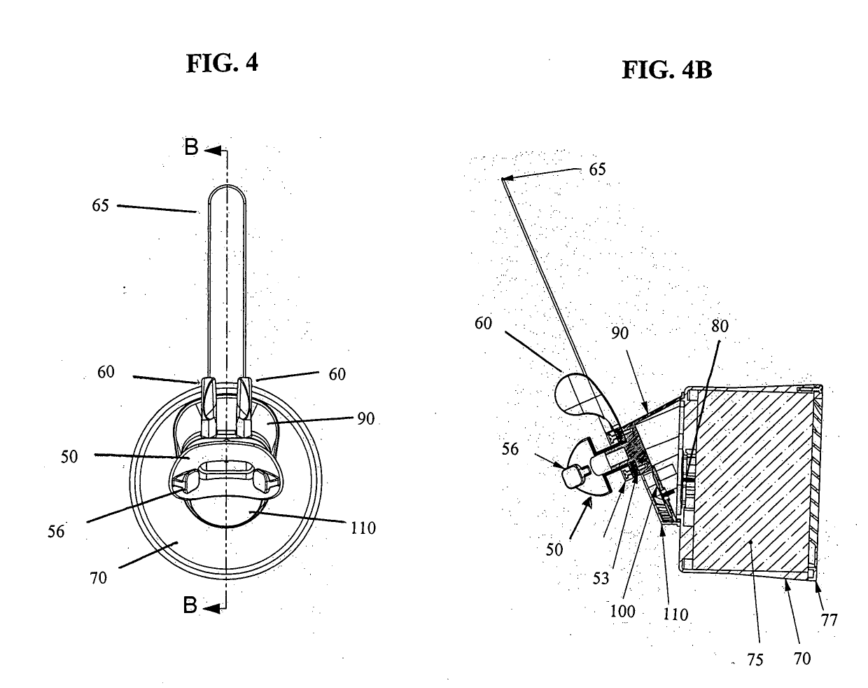

A filter assembly according to the invention in a fully assembled condition is shown in the embodiment illustrated in FIG. 4 and FIG. 4B. FIG. 4 particularly shows a rear view of one embodiment of the filter assembly, and FIG. 4B shows a cross sectional view of the filter assembly of FIG. 4 along the line B-B.

In this embodiment of the invention, the filter assembly comprises a filter housing 70, which can comprise any suitable material providing structural protection for the filter component 75. For example, the filter housing 70 can comprise a lightweight metal, such as aluminum, or a heat-resistant plastic. Preferentially, the filter housing 70 is comprises a polymeric material, such as an acrylonitrile-butadiene-styrene material.

The filter component 75 most preferably incorporates HEPA technology. High-Efficiency Particulate Air (HEPA) filters, formerly known as high-efficiency particulate arrestors, were originally developed by the military for nuclear particle filtration and were first used during World War II in nuclear reactor facilities for preventing escape of radioactive particles through exhausts. Today, HEPA technology is the industry standard for particulate filtration in areas of vital technology, such as hospital operating rooms, military clean rooms, semi-conductors clean rooms, and the like.

HEPA filters are generally define as extended-surface dry-type filters with a minimum particle removal efficiency of 99.97% for all particles having a diameter greater than or equal to 0.3 microns. HEPA filters are superior to activated carbon and similar type filtration systems not only in particle removal efficiency, but also in the breadth of contaminants that can be removed. HEPA filters are generally regarded as being efficient for removal of most harmful particulate matter including smoke, dust, asbestos, bacteria and other pathogens, radioactive dust, mold spores, and the like. Accordingly, the air purifying escape hood of the invention, particularly in it use of HEPA technology, exhibits greater efficiency in protection of a user against smoke. Such increased protection correlates to increased usable time, meaning a user has a greater time-frame for escaping from a burning structure. Such increased useful escape time is particularly useful in office-type settings, where buildings from which individuals might be evacuated commonly have up to as many as 100 floors. As such, an individual required to exit a 50-story building, for example, through a smoke-filled stairwell could require an exit time well in excess of the 10-15 minutes of smoke protection commonly afforded by previously known smoke hoods.

In addition to the above, the air purifying escape hood of the invention, through the use of HEPA technology, provides efficient protection far beyond the scope of protection afforded by the prior art smoke hoods, which is generally limited to smoke alone. Rather, the air purifying escape hood of the invention protects users against a broad spectrum of dangerous, and deadly, particulate matter. Further, the air purifying escape hood also protects users against the increasingly realistic threat of chemical and biological threats, such as chemical nerve agents and biological agents, such as anthrax, smallpox, and the like. Additionally, the broad scope protection provided by the air purifying escape smoke hood of the invention is effective against radioactive particles.

As further illustrated in FIGS. 3 through 4B, in one embodiment of the invention, the filter component 75 fits into the filter housing 70, and the filter cover 77 is attached over the outer opening of the filter housing 70. The filter cover 77 is air permeable to allow sufficient air flow into the filter assembly. Preferentially, the filter cover 77 comprises a material that is flame retardant and heat resistant, such as plastics incorporating magnesiumhydroxide (MDH).

In one particular embodiment, the rear surface of the filter housing 70 has an aperture for receiving filter valve 80. Preferentially, the filter valve is a check valve that functions to allow air flow to move posteriority out of the filter housing 70 but also functions to prevent air flow in the reverse direction through the filter valve 80 and into the filter housing 70 (i.e., in an anterior direction). Accordingly, the check valve allows movement of air from the HEPA filter into the further components of the filter assembly for inhalation by the user.

Covering the filter valve 80 and attaching to the posterior surface of the filter housing 70 is an air distribution chamber 90, which provides an air exchange area where filtered air for inhalation coming from the filter housing 70 is received through filter valve 80 and is then available for inhalation by the user through the mouthpiece 50. Likewise, exhaled air from the user moves back through the mouthpiece 50 into the air distribution chamber 90 for exiting the filter assembly.

Exhaled air exits the filter assembly through the exhalation valve 100, which is disposed on the posterior surface of the air distribution chamber 90. Covering and protecting the exhalation valve 100, and also attached to the posterior surface of the air chamber 90, is an exhalation valve cover 110. The exhalation valve cover 110 is preferentially slotted to allow sufficient air flow out of the air chamber 90 through the exhalation valve 100. As before, it is preferable for the exhalation valve to be a check valve that functions to allow air flow in only a single direction. Accordingly, the filter valve and the exhalation valve can be referred to herein as a first check valve and a second check valve, respectively.

In one preferred embodiment, the filter valve and the exhalation valve are both check valve. Preferentially, in this embodiment, the filter assembly includes the air distribution chamber situated between the filter component and a mouthpiece component, each of the check valves being aligned in parallel on opposite sides of the air distribution chamber. The first check valve is situated on the posterior wall of the filter housing, and the second check valve is situated on the posterior wall of the air distribution chamber opposite the first check valve. The direction of opening for both check valves in this embodiment is toward the user. Therefore, in one embodiment, when the user inhales, the first valve is opened by the air flow allowing filtered air into the air distribution chamber to be directed to the mouthpiece for inhalation by the user. In this alignment, the flow of air into the air distribution chamber is also in the direction of opening for the second check valve. Accordingly, the prevent movement of the filtered air out of the second check valve, the second check valve should be adjusted to an opening pressure that does not allow opening of the second valve during inhalation by the user. Such adjustment is easily accomplished as the air flow pressure is greatly directed toward the mouthpiece, which is positioned above the second valve. Accordingly, in the inhalation phase, pressure at the lower portion of the air distribution chamber is reduced and the second check valve is not subjected to an opening pressure.

When the user exhales through the mouthpiece, the exhaled air enters the air distribution chamber and pushes against the first check valve maintaining a closed position for the first check valve. Therefore, a sufficient pressure is achieved in the lower portion of the air distribution chamber to open the second check valve. Once exhalation ceases, the second check valve closes, preventing return of air through the second check valve and into the air distribution chamber.

In one preferred embodiment, the air distribution chamber is positioned internal to the hood assembly. According to this embodiment, exhaled air passes from the mouthpiece, into the air chamber, through the second check valve, and out the valve cover into the interior space of the hood assembly. Allowing air to escape into the hood assembly is beneficial in multiple regards. First, doing so creates a positive air pressure inside the hood assembly, which keeps the hood assembly from collapsing and pressing against the face and head of the user. While such collapsing would not be expected to be harmful to the user or detrimental to the function of the air purifying escape hood, such a collapsing of the hood could be perceived by the user as inappropriate or be fear-inducing, causing the user to remove the escape hood. Additionally, the creation of the positive air pressure inside the hood facilitates formation of a gas barrier around the head of the user. This helps eliminate the passage of any contaminated air past the neck seal of the hood assembly and into the interior portion of the hood assembly. Further, having the exit point for exhaled air be interior to the hood eliminates the possibility of back flow of contaminated air into the air distribution chamber. If the exit point for exhaled air was exterior to the hood assembly, the open of the second check valve could allow contaminated air to enter the air distribution chamber and be mixed with the filtered air for inhalation by the user.

Any one-way valve known to one of skill in the art would be useful according to the invention. Particularly preferred are one way valves such as those available from Vernay. The one-way valve is preferentially an umbrella check valve, which is a pressure sensitive valve allowing for opening at predetermined pressures and normally closed sealing at zero pressure differentials. Of course, other similarly effective valves would also be useful in the air purifying escape hood of the invention.

As noted above, in certain embodiments, the filter assembly of the invention further comprises a mouthpiece assembly, which is preferentially arranged to be interior to the area where the filter assembly is sealably attached to the hood assembly. The mouthpiece 50, is preferably formed to fit comfortably into the mouth of the user. The mouthpiece 50 preferentially comprises a non-toxic, non-reactive material that is comfortable for use in the mouth of a user of the air purifying escape hood. In one embodiment, the mouthpiece comprises a silicone rubber material.

In further embodiments, disposed on the posterior surface of the mouthpiece 50 is a stabilizing projection 56, which is provided to allow the user to grip the mouthpiece 50 with the user's teeth, thereby disallowing the mouthpiece 50 from slipping out of the mouth of the user. The mouthpiece 50 is preferentially attached to the posterior surface of the air distribution chamber 90 with a mouthpiece support 53.

In one embodiment, the filter assembly further comprises a component for at least partially inhibiting breathing of the user through the nasal passages. The nasal breathing inhibiting component can include a mechanism for pinching closed the nostrils of the user. As seen in the accompanying drawings, the nasal breathing inhibiting component is a nose blocker component 60. Preferably, the nose blocker component 60 is conveniently positioned for sliding onto the nose of the user to prevent breathing through the nose. It is beneficial to prevent breathing through the nose because even though the air purifying escape hood is equipped with the neck seal component, it does not form an impenetrable air-tight seal to the surrounding environment. Accordingly, there remains the possibility that contaminated air could move past the neck seal and into the cavity of the hood assembly. If breathing through the nose is prevented, it is not possible for any contaminated air to enter the lungs of the user as all breathing is through the mouth, which is in connection with the mouthpiece component of the filter assembly.

The nose blocker comprises two partially flattened projections extending upward from the mouthpiece. The projections are generally spaced about 0.5-2 cm apart, the spacing being that required to fit over the bridge of the nose of the user, pinching the sides of the nose toward the center of the nose, effectively closing the breathing passages of the nose. To facilitate the fit of the nose blocker to a wide range of nose sizes, the two projections can be thickened in the anterior portion making a smaller gap between the two projections, and the projections can further be tapered outward toward the posterior portion of the projections, making the distance between the projections greater at the posterior portion.

In yet another embodiment of the invention, extending upward from nose blocker component 60 is a tension wire 65, which provides tension to the nose blocker 60, increasing the pressure on the nostrils of the user, preventing breathing into or out of the nose. The tension wire 65 is further functional in that is provides support to the hood assembly, particularly keeping the visor from drooping and thereby inhibiting clear vision by the user.

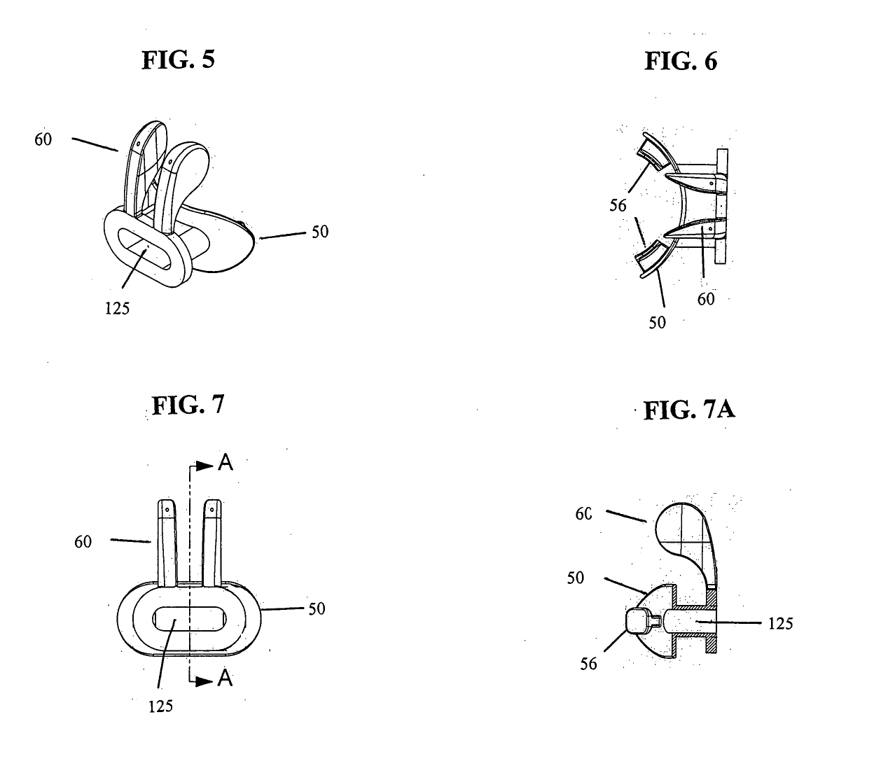

The mouthpiece is preferably ovular in shape, being elongated along a horizontal axis, to comfortably fit into the mouth of the user. One embodiment of the mouthpiece assembly for use with an air purifying escape hood according to the present invention is shown in greater detail in FIG. 5 through FIG. 7A. FIG. 5 shows an anterior perspective view of the mouthpiece assembly, which has a hollow chamber 125 running therethrough. As can be particularly seen in FIG. 6, each of the projections the nose blocker 60 is substantially linear along the outer surface but is tapered along the inner surface. In other words, each of the projections of the nose blocker 60 is thickened in the anterior portion but tapers to a thinner point at the posterior end. This allows the nose blocker 60 to easily fit onto the nose of the user, and also allows the nose blocker 60 to snugly fit noses of varying sizes.

The disposition of the stabilizing projection 56 is also more clearly seen in FIG. 6. Preferentially, the positioning of the stabilizing projection 56 is to the outer edge of the mouthpiece 50. Accordingly, the stabilizing projection 56 is useful for allowing the user to grip the mouthpiece with the user's teeth, thereby stabilizing the mouthpiece in the user's mouth. However, the stabilizing projection 56, being positioned to the outside of the mouthpiece 50, does not interfere with the flow of air through the hollow chamber 125.

As seen in FIG. 3, the filter assembly is formed such that when assembled, it easily fits into a storage container 150. While it is not shown in FIG. 3, when the air purifying escape hood according to the present invention is fully assembled, the hood assembly is also present for storage in storage container 150. As such, in its assembled state, the air purifying escape hood is preferentially assembled such that the filter housing 70 and the filter housing cover 77 are essentially the only components of the filter assembly that are visible outside of the hood assembly. Thus, the hood assembly is preferably sealably attached to the filter assembly at about the position where the air chamber 90 attaches to the posterior surface of the filter housing 70. Accordingly, the mouthpiece 50, the nose blocker 60, the tension wire 65, the exhalation valve cover 110, the exhalation valve 100, and at least a portion of air distribution chamber 90 are disposed within the hood assembly.

According to one preferred embodiment of the present invention, when the air purifying escape hood is being prepared for storage, the hood assembly is folded around the mouthpiece assembly and the other parts of the filter assembly that are interior to the hood assembly. The air purifying escape hood is then inserted into the storage container 150 such that the hood assembly folded around the portions of the filter assembly that are interior to the hood assembly is inserter first into the storage container. The last part of the air purifying escape hood to be placed into the storage container is the filter housing containing the filter.

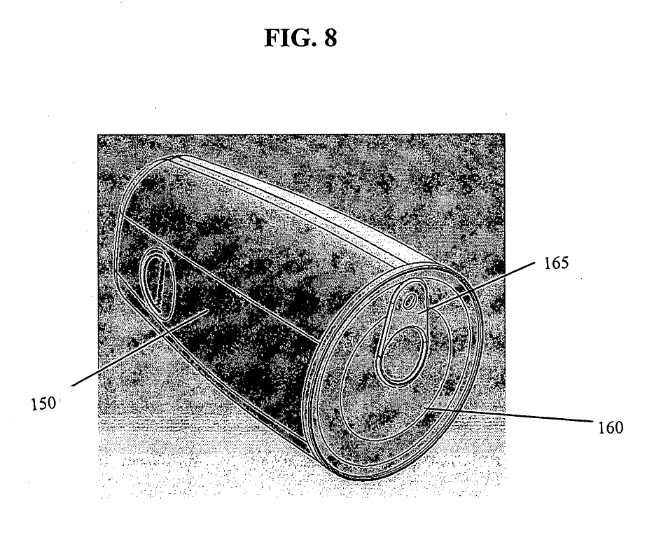

Preferentially, once the air purifying escape hood is placed in the storage container, the container is vacuum sealed with a storage container lid. In a preferred embodiment, the storage container lid is easily opened with a pull ring. FIG. 8 shows one embodiment of a storage container for storing an air purifying escape hood according to the present invention. The storage container 150 is vacuum sealed with a storage container lid 160 that can be conveniently and easily opened with pull ring 165. Preferentially, the storage container is visibly marked in a manner making it easily identifiable by a prospective user in a situation requiring use of the air purifying escape hood.

To remove the air purifying escape hood from the storage container, a user has only to lift and pull the pull ring. The air purifying escape hood is then pulled from the storage container by grasping the filter housing and pulling the air purifying escape hood from the storage container. Once removed from the storage container, the user need only to unfold the hood assembly, stretch open the neck seal, and place the hood assembly over the user's head. Once the hood assembly is placed over the user's head, the user can insert the mouthpiece into the user's mouth, ensure the nose block is securely placed over the nose, and begin breathing normally through the mouth.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An air purifying escape hood comprising:
a hood assembly comprising
a hood body having an inner layer and an outer layer,
a hood visor, and
a silicon rubber neck band; and
a filter assembly comprising
a HEPA filter,
a mouthpiece,
an air distribution chamber,
a first check valve for allowing movement of air from the HEPA filter to the air distribution chamber for inhalation, and
a second check valve for allowing movement of expelled air out of the air distribution chamber;
wherein the first check valve and the second check valve are aligned in parallel, and
wherein the second check valve is positioned such that air expelled by the user exits the filter assembly inside the hood assembly.

2. An air purifying escape hood comprising:
a hood assembly comprising
a hood body, and
a hood visor;
and a filter assembly comprising
a HEPA filter,
a mouthpiece,
an air distribution chamber,
a first check valve, and
a second check valve.

3. The air purifying escape hood according to claim 2, wherein the hood assembly further comprises a neck seal component.

4. The air purifying escape hood according to claim 3, wherein the neck seal component includes a band of silicon rubber.

5. The air purifying escape hood according to claim 2, wherein said hood body comprises an inner layer and an outer layer.

6. The air purifying escape hood according to claim 5, wherein the outer layer comprises a fire-retardant or fire-resistant material.

7. The air purifying escape hood according to claim 6, wherein the outer layer comprises a polyester resin.

8. The air purifying escape hood according to claim 5, wherein the inner layer comprises a barrier material.

9. The air purifying escape hood according to claim 8, wherein the inner layer comprises polytetrafluoroethylene.

10. The air purifying escape hood according to claim 2, wherein the filter assembly further comprises a component for at least partially inhibiting breathing of the user through the nasal passages.

11. The air purifying escape hood according to claim 10, wherein the filter assembly further comprises a tension wire extending from the nasal breathing inhibiting component.

12. The air purifying escape hood according to claim 11, wherein the tension wire attached to the hood assembly for at least partially supporting the hood visor.

13. The air purifying escape hood according to claim 2, wherein at least one of the first check valve and the second check valve is an umbrella check valve.

14. The air purifying escape hood according to claim 2, wherein the first check valve and the second check valve are aligned in parallel.

15. The air purifying escape hood according to claim 2, wherein the first check valve allows movement of air from the HEPA filter to the air distribution chamber for inhalation.

16. The air purifying escape hood according to claim 2, wherein the second check valve allows movement of expelled air out of the air distribution chamber.

17. The air purifying escape hood according to claim 16, wherein the second check valve is positioned such that air expelled by the user exits the filter assembly inside the hood assembly.

18. The air purifying escape hood according to claim 2, wherein the hood assembly is sealably attached to the filter assembly.

19. The air purifying escape hood according to claim 18, wherein a portion of the filter assembly is interior to the hood assembly and a portion of the filter assembly is exterior to the hood assembly.

20. A packaged air purifying escape hood for emergency breathing, the packaged escape hood comprising:
an air purifying escape hood comprising
a hood assembly comprising
a hood body, and
a hood visor;
and a filter assembly comprising
a HEPA filter,
a mouthpiece,
an air distribution chamber,
a first check valve, and
a second check valve;
wherein the air purifying escape hood is packaged in a storage container comprising a sealable container and a sealing container lid.

21. The packaged air purifying escape hood according to claim 20, wherein the air purifying escape hood is vacuum sealed in the sealable container with the sealing lid.

22. The compact, storable emergency breathing unit according to claim 20, wherein the sealing lid further comprises a pull ring.
